(19) United States
(12) Patent Application Publication
(10) Pub. No.: US 2014/0207653 A1
(43) Pub. Date: Jul. 24, 2014

(54) SYSTEM, PROGRAM AND METHOD FOR PROVIDING A SECURED CREDIT CARD COLLATERALIZED BY A TAX REFUND

(71) Applicant: BRADLEY C. HANSON, HARRISBURG, SD (US)

(72) Inventor: BRADLEY C. HANSON, HARRISBURG, SD (US)

(21) Appl. No.: 14/154,337

(22) Filed: Jan. 14, 2014

Related U.S. Application Data
(60) Provisional application No. 61/754,133, filed on Jan. 18, 2013.

(51) Int. Cl. G06Q 40/00; G06Q 20/24; G06Q 20/34

(52) U.S. Cl. CPC G06Q 40/10; G06Q 20/342; G06Q 20/24; G06Q 40/025
USPC 705/38

(57) ABSTRACT

A system, program and method of providing a secured credit card product to a customer may comprise steps generally relating to preparing a tax return for a customer for a previous year, and determining, based upon the preparation of the tax return, whether the customer is entitled to receive a tax refund. If the customer is entitled to receive a tax refund, offering a secured credit card product to the customer; determining if the customer meets eligibility requirements for the secured credit card product; and receiving the tax refund and using at least a portion of the amount of the tax refund of the customer to provide collateral for the secured credit card product of the customer.

### REFERENCE TO RELATED APPLICATIONS

This application claims priority to and the benefit of U.S. Provisional Patent Application Ser. No. 61/754,133 by Bradley C. Hanson titled “System, Program And Method For Providing A Secured Credit Card Collateralized By A Tax Refund” filed Jan. 18, 2013, which is incorporated herein by reference in its entirety.

### BACKGROUND

### Field

The present disclosure relates to secured credit card programs and more particularly pertains to a new system, program and method for providing a secured credit card that is collateralized by a tax refund that may be initially offered to the potential customer in the context of preparing the tax return for the customer.

### SUMMARY

In general, the present disclosure describes new systems, computer program products and computer implemented methods for providing a secured credit card collateralized by a tax refund which may be utilized for providing an alternative to customers who might otherwise utilize a refund anticipation loan and who would like to avoid some of the negative aspects of such loans. In some implementations, the secured credit card product may be offered to the potential customer of the product at the time of preparing the tax return of the customer, which may provide significant benefits in the evaluation of the suitability of the product for the customer and the customer's qualifications for applying for the product.

In one aspect, the present disclosure relates to a method of providing a secured credit card product to a customer. The method may comprise receiving eligibility information transmitted over a communication network from a tax preparation entity, with the eligibility information regarding preparation of a tax return for the customer and including an amount of a tax refund that the customer is entitled to receive. The method may also comprise determining if the customer meets eligibility requirements for the secured credit card product based in part upon the eligibility information, and transmitting a conditional approval for the secured credit card product for the customer if the customer meets the eligibility requirements. The method may also comprise, if the customer is conditionally approved, receiving additional eligibility information over a communication network from the customer to approve the customer for the secured credit card product, and receiving the tax refund in a disbursement account and transferring at least a portion of the amount of the tax refund of the customer from the disbursement account to a collateral account to provide collateral for the secured credit card product of the customer.

In another aspect, the disclosure relates to a method of providing a secured credit card product to a customer. The method may comprise preparing a tax return for a customer for a previous year, and determining, based upon the preparation of the tax return, whether the customer is entitled to receive a tax refund. The method may comprise, if the customer is entitled to receive a tax refund, offering a secured credit card product to the customer, determining if the customer meets eligibility requirements for the secured credit card product, and receiving the tax refund and using at least a portion of the amount of the tax refund of the customer to provide collateral for the secured credit card product of the customer.

In still another aspect, the disclosure relates to a system for providing a secured credit card product to a customer. The system may comprise a first computer associated with a bank and a second computer associated with a tax preparation entity, with the first computer being communicatively connected to the second computer by a communications network and the first computer including a processor and memory. The system may also include a computer program product stored on a tangible computer memory media associated with the first computer and being operable on at least the first computer. The computer program product may include instructions executable by at least the first computer to cause the first computer to perform the step of receiving eligibility information transmitted over the communication network from the second computer, with the eligibility information comprising information regarding preparation of a tax return for the customer by the tax preparation entity for the customer and including an amount of a tax refund that the customer is entitled to receive. The instructions may further include instructions to perform the steps of determining if the customer meets eligibility requirements for the secured credit card product based in part upon the eligibility information and transmitting a conditional approval for the secured credit card product for the customer if the customer meets the eligibility requirements. The instructions may further include instructions to perform the steps of, if the customer is conditionally approved, receiving additional eligibility information over the communication network from the customer to approve the customer for the secured credit card product and transmitting a notification to the second computer regarding approval of the customer for the secured credit card product. The instructions may also include instructions to perform the step of transferring at least a portion of the amount of the tax refund of the customer from a disbursement account to a collateral account to provide collateral for the secured credit card product of the customer.

In yet another aspect, the disclosure relates to a computer program product stored on a tangible computer memory media associated with a first computer and operable on the first computer, and the computer program product includes instructions executable by the first computer to cause the first computer to perform steps. The steps may include receiving eligibility information transmitted over a communication network from a second computer, with the eligibility information comprising information regarding preparation of a tax return for the customer by the tax preparation entity for the customer and including an amount of a tax refund that the customer is entitled to receive. The steps may also include determining if the customer meets eligibility requirements for the secured credit card product based in part upon the eligibility information, and transmitting a conditional approval for the secured credit card product for the customer if the customer meets the eligibility requirements. The steps may further include, if the customer is conditionally approved, receiving additional eligibility information over a communication network from the customer to approve the customer for the secured credit card product and transmitting a notification to the second computer regarding approval of the customer for the secured credit card product. The steps may still further include transferring at least a portion of the amount of the tax refund of the customer from a disbursement account to a collateral account to provide collateral for the secured credit card product of the customer.

There has thus been outlined, rather broadly, some of the more important aspects and elements of the disclosure in order that the detailed description thereof that follows may be better understood, and in order that the present contribution to the art may be better appreciated. There are additional aspects and elements of the disclosure that will be described hereinafter and which will form the subject matter of the claims appended hereto.

The advantages of the various embodiments and implementations of the present disclosure, along with the various features of novelty that characterize the disclosure, are disclosed in the following descriptive matter and accompanying drawings.

### BRIEF DESCRIPTION OF THE DRAWINGS

The disclosure will be better understood and when consideration is given to the drawings and the detailed description which follows. Such description makes reference to the annexed drawings wherein:

FIG. 1 is a schematic flow diagram of a new method for providing a secured credit card collateralized by a tax refund according to the present disclosure.

FIG. 2A is a schematic flow diagram of a portion of a more detailed example of an illustrative process of the disclosure.

FIG. 2B is a schematic flow diagram of another portion of the illustrative process of the disclosure.

FIG. 2C is a schematic flow diagram of yet another portion of the illustrative process of the disclosure.

FIG. 2D is a schematic flow diagram of still another portion of an illustrative process of the disclosure.

FIG. 2E is a schematic flow diagram of still yet another portion of the illustrative process of the disclosure.

FIG. 2F is a schematic flow diagram of a further portion of the illustrative process of the disclosure.

FIG. 2G is a schematic flow diagram of a still further portion of the illustrative process of the disclosure.

FIG. 2H is a schematic flow diagram of a yet further portion of the illustrative process of the disclosure.

FIG. 2I is a schematic flow diagram of a portion of the illustrative process shown in FIG. 2H.

FIG. 3 is a schematic diagram of various elements of the system of the disclosure, according to an illustrative embodiment.

FIG. 4 is a schematic diagram of a program product stored in memory and executable by a computer according to an embodiment of the present disclosure.

### DETAILED DESCRIPTION

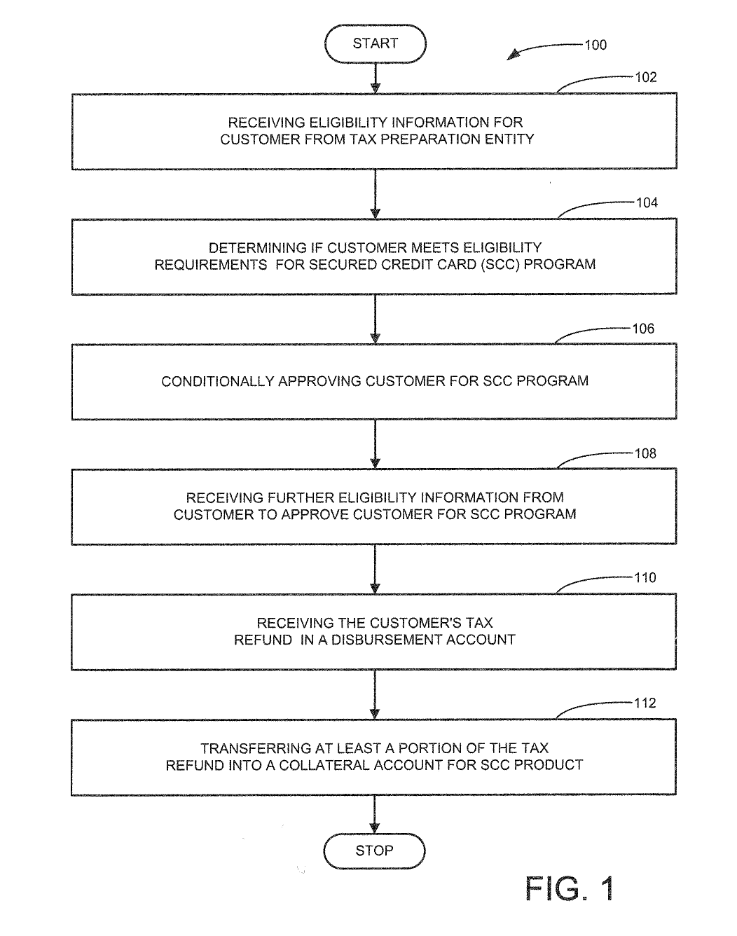

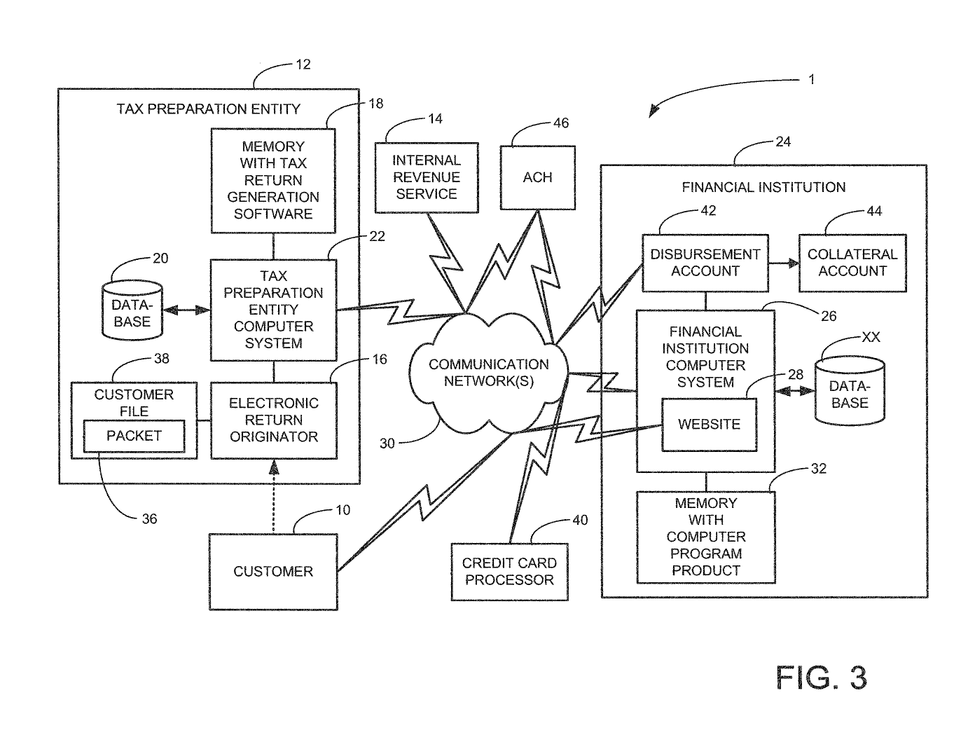

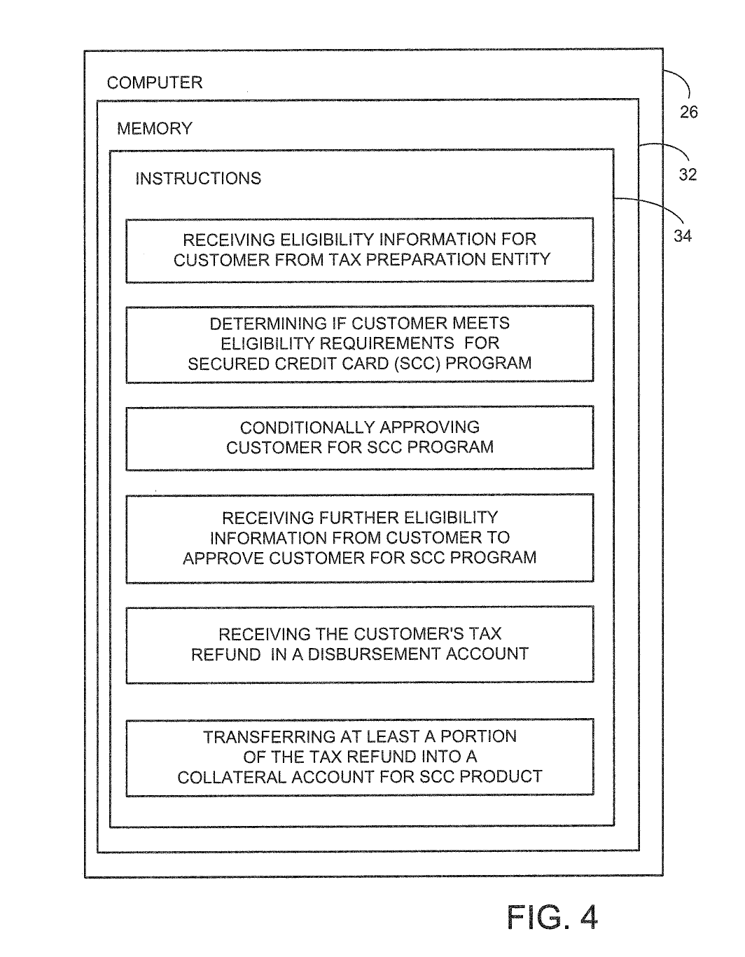

With reference now to the drawings, and in particular to FIGS. 1 through 4 thereof, a new system, program and method for providing a secured credit card collateralized by a tax refund embodying and implementing the principles and concepts of the disclosed subject matter will be described. Those skilled in the art will appreciate that the conception, upon which this disclosure is based, may readily be utilized as a basis for the designing of other systems, methods and products for carrying out the several purposes of the present disclosure. It is important, therefore, that the claims be regarded as including such equivalent implementations insofar as they do not depart from the spirit and scope of the present disclosure.

The applicants have recognized a need, in view of changing consumer perceptions and preferences as well as changing regulatory environments, for providing customers with new options for receiving tax refunds that may avoid some of the less favorable aspects of other options currently utilized by the public. These options include, for example, refund anticipation loans that provide the customer with an immediate advance of a portion of the customer's anticipated tax refund, often at a substantial cost to the customer that makes this option less attractive to the customer and regulators.

In this environment, the applicants have conceived the following systems, programs and methods for providing a secured credit card collateralized by a tax refund. The applicants have recognized that the issuance of a tax refund to a taxpayer presents a highly suitable means of funding the collateral required for a secured credit card product for persons that otherwise might not be qualified for a non-secured credit card and might not otherwise be able to provide the initial collateral for opening a secured credit card account. The applicants have further recognized that the tax preparation environment presents an ideal time to present the availability of the secured credit card product and program to the potential customer, as it facilitates the identification of those persons who are actually likely entitled to receive a tax refund and could utilize the program, as well as providing a suitable context for at least initially determining the eligibility of the customer for the program.

In greater detail, the aspects of the present disclosure are highly suitable for the context of tax return preparation services due to the likelihood that the preparation and filing of the tax return will result in a refund of money to the taxpayer, and the taxpayer may be interested in and receptive to receiving the tax refund in a manner that is different from a direct deposit to a checking or savings account of the customer or mailing the check to the customer, as the customer may not have such an account or an address to which he or she desires to have a paper check mailed. Further, while the customer may be anxious to receive the funds of the tax refund as soon as possible, he or she may also wish to avoid taking a loan of money in anticipation of the receipt of the tax refund, such as by a refund anticipation loan (RAL), so a relatively faster manner of obtaining access to the funds of the refund may be attractive.

The disclosure describes a number of illustrative implementations relating to the provision of tax return preparation services, such as system 1 and processes 100 and 200 shown in the Figures, and in this context the recipient of the services is generally referred to as the customer 10, and the provider of the services is referred to as a tax preparation entity 12 or tax preparer. In greater detail, the customer may be a person or persons who desires to have their income tax return prepared by a service provider having some degree of skill or training in the preparation of tax returns. The illustrative implementations are primarily directed to a customer who is a taxpayer (or at least subject to file an income tax return, even if no taxes are due to be paid by the taxpayer) desiring to file a federal tax return with the Internal Revenue Service (IRS). Tax return filing is often done in anticipation of receiving a refund of at least a portion of monies that, for example, had been withheld from the paycheck of the taxpayer at his or her employment. Although tax refunds are commonly associated with the filing of an income tax return, whether on a federal or state government level, the aspects of the disclosure are not so limited in application and may be applied to other types or forms of taxes, and for different levels of government taxation.

Also, for the purposes of this illustrative description, the tax preparation entity 12 is generally in the business of preparing tax returns for customers and submitting those tax returns to the appropriate governmental entity 14 that is designated to receive and process tax returns (such as the IRS) and direct the payment of a tax refund in response to the submission of the tax return. For the purposes of this description, the terms “tax preparation entity” and “tax preparer” may be used interchangeably, and will be referred to in the singular, although it should be recognized that these terms as used herein may include multiple people or entities. For example, the tax preparation entity may include a local branch office or franchisee (sometimes referred to as an electronic return originator (ERO) 16) and a larger tax preparation service corporation or franchisor. While separate entities in some respects, the entities have some regular business connection and in many cases share an information technology connection or system that allows for easy communication of information therebetween. In many cases, the corporate tax preparation entity may develop and administer tax return software 18 and databases 20 maintained on a computer system or server 22 that is utilized by the local tax preparer through a network in completing the tax return for a customer who typically meets directly with the local tax preparer 16.

The secured credit card program of the disclosure may be administered by a financial institution 24, such as a bank. While the terms “financial institution” and “bank” may be used interchangeably in this disclosure, it should be recognized that this entity is not necessarily limited to a bank. The use of these terms is intended to include financial institutions that are in the position of providing the services, or taking the actions, that are described herein, whether directly or indirectly through other entities retained to provide such services. Thus, this entity is not necessarily limited to entities that provide banking services. The financial institution 24 may maintain a computer system 26 that has access to a database and storage. The computer system 26 may support a website 28 (either directly or indirectly on another computer system) that includes webpages that are accessible through a communication network 30, such as the network commonly referred to as the World Wide Web or Internet. The computer system 26 may include memory 32 or storage on which application programs 34 of instructions may be stored in a manner to be used by the system 26 to provide processes such as processes 100 and 200 described below.

Turning first to FIG. 1, process 100 depicts steps of an illustrative implementation of the disclosure which are further elaborated upon in process 200. Initially, eligibility information is received from tax preparation entity 12 for a customer 10 of the tax preparer (block 102), and the information may be derived from a meeting with the customer to prepare a tax return for the customer. A determination is made whether the customer meets initial eligibility requirements for the secured credit card (SCC) program (block 104). The customer may be conditionally approved for the SCC program (block 106) if the initial eligibility requirements are met. If conditionally approved, further eligibility information may be received, and may be required, from the customer to approve the customer for the SCC program (block 108). The customer's tax refund may be received in a disbursement account (block 110), and at least a portion of the tax refund may be transferred into a collateral account to collateralize or secure the SCC of the customer (block 112), and the customer may proceed to use the SCC product.

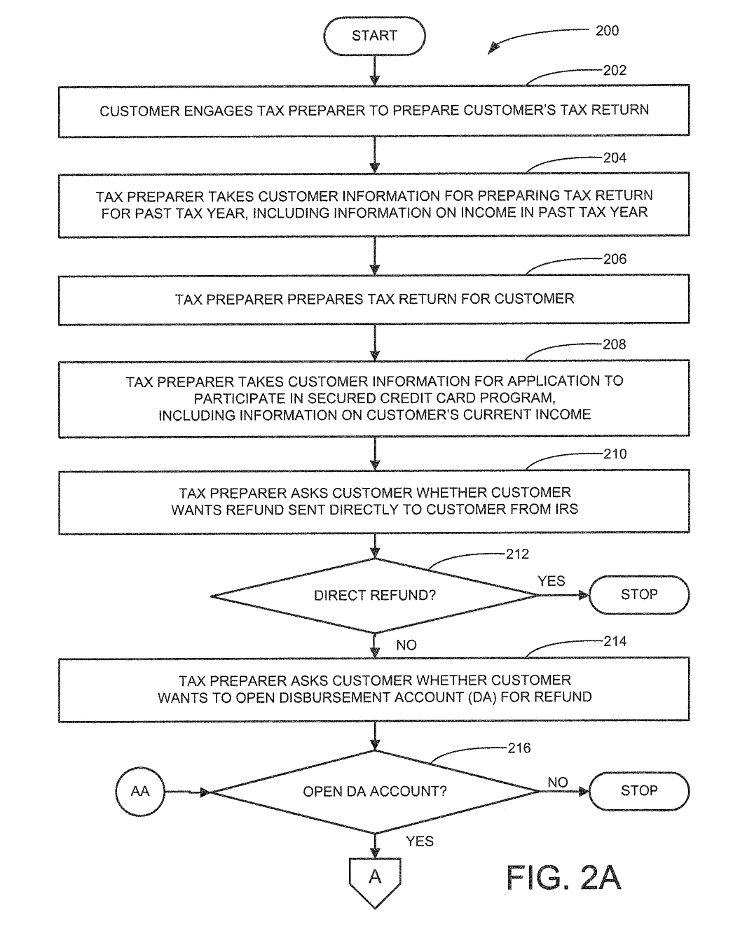

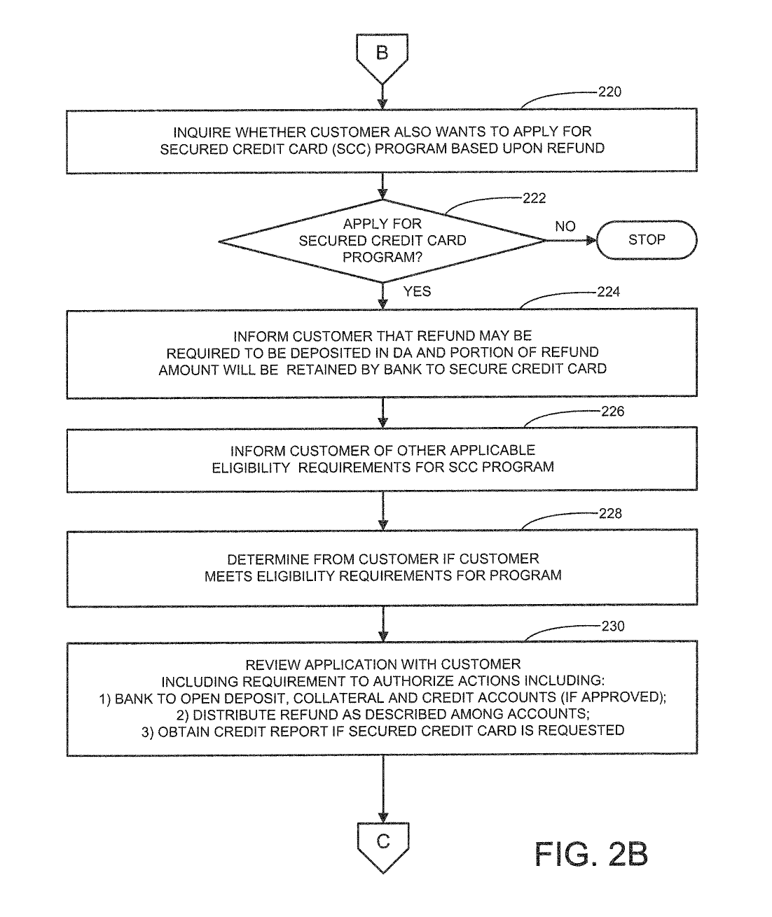

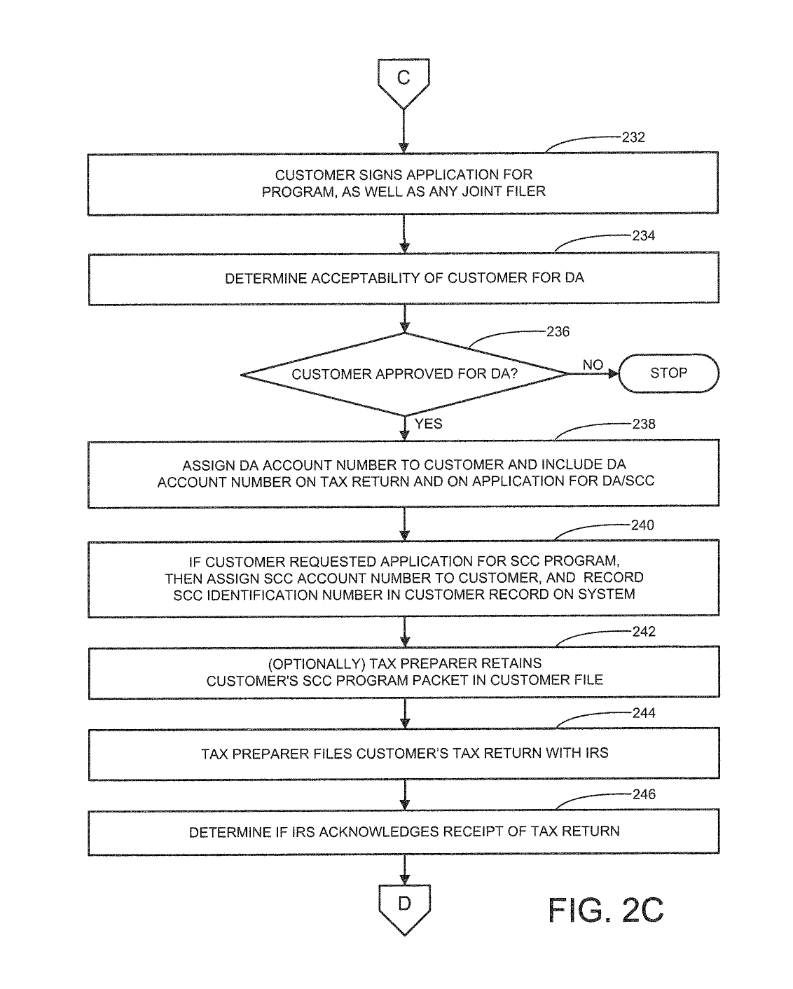

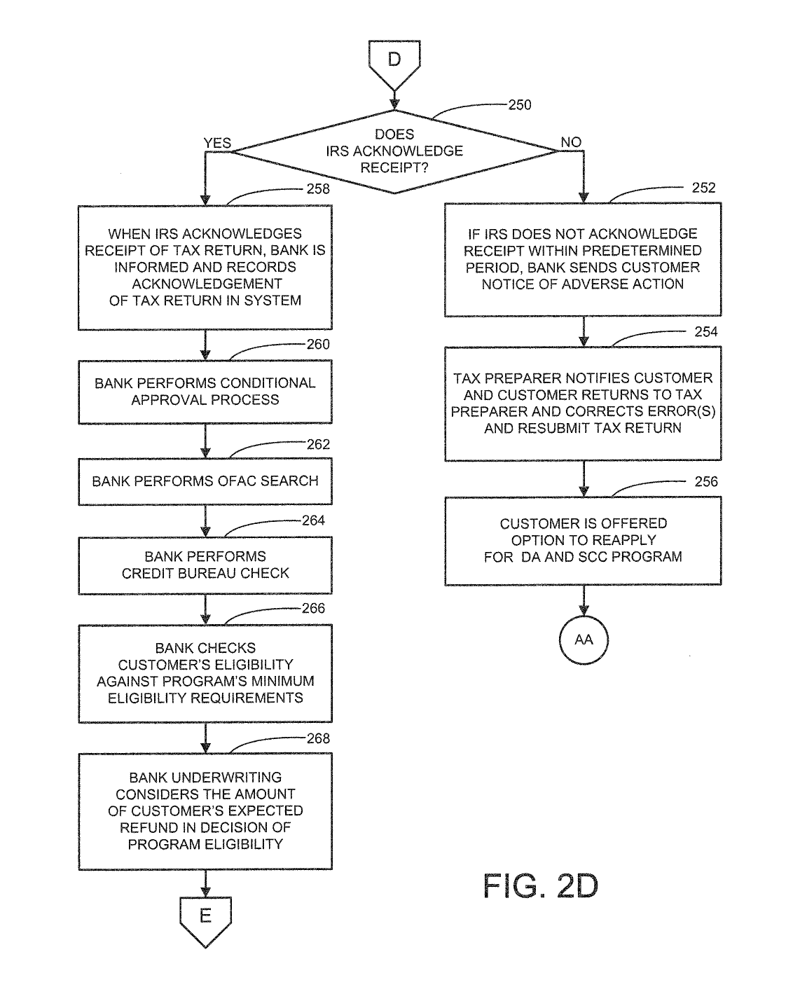

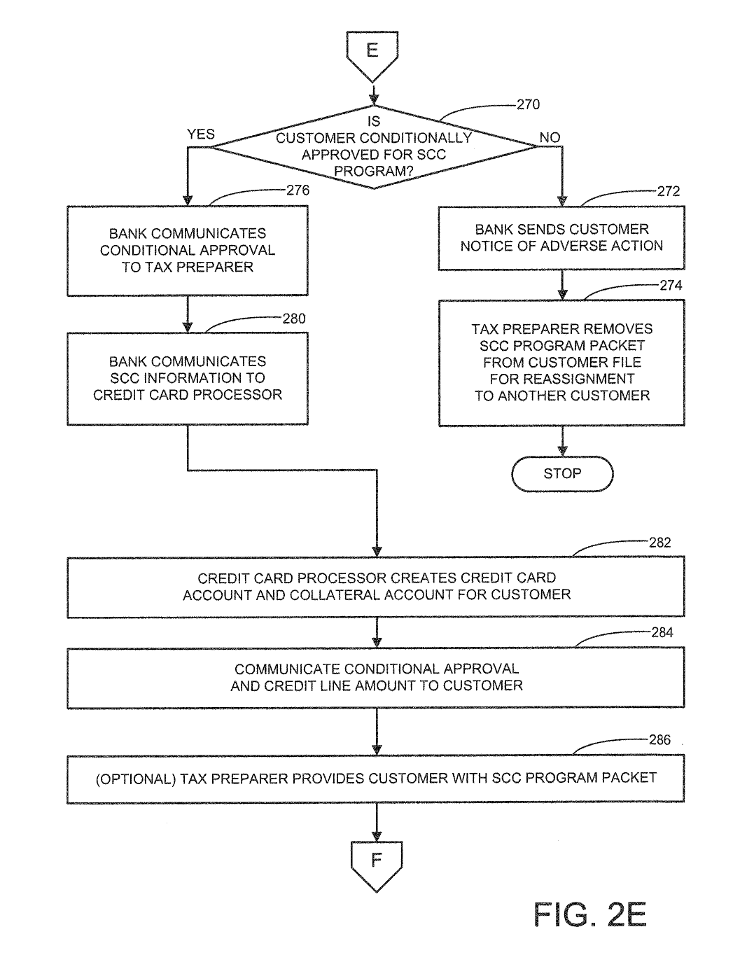

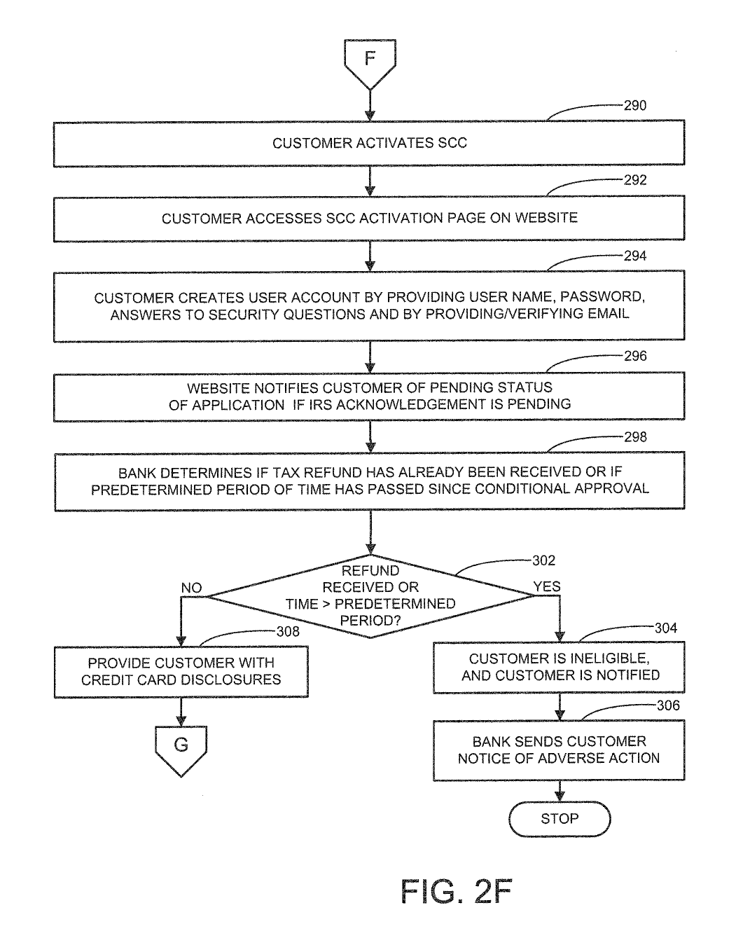

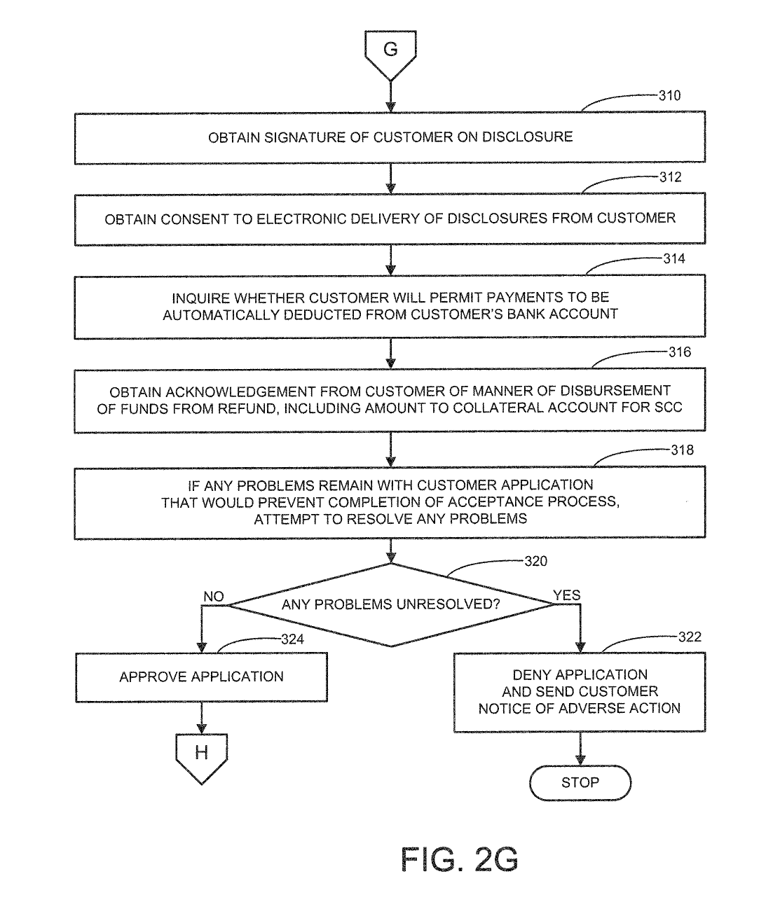

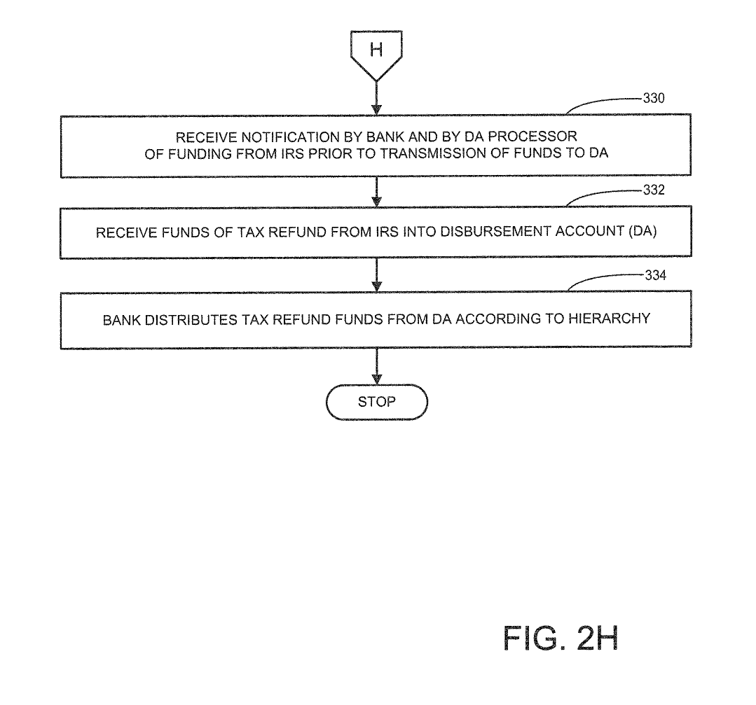

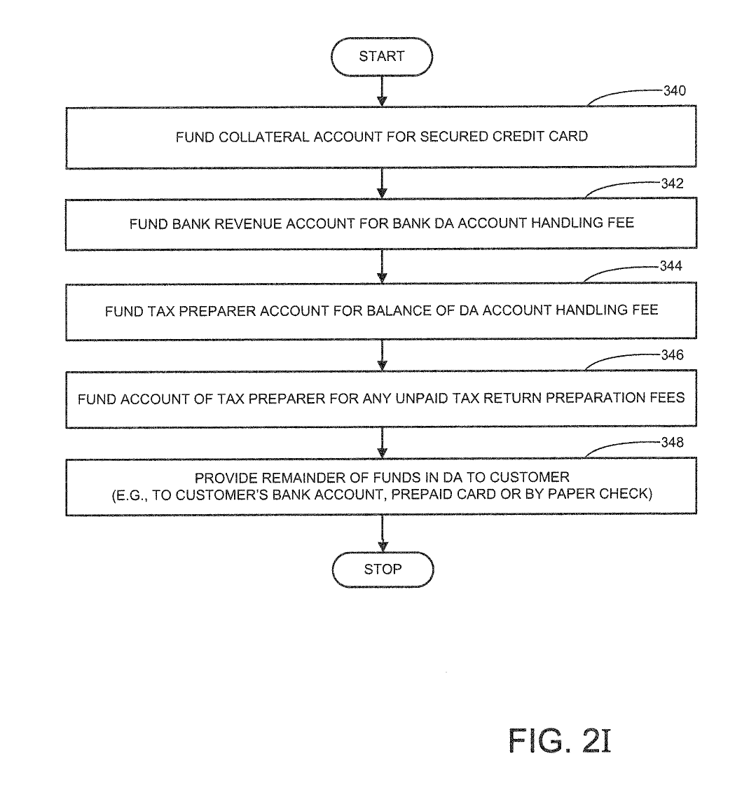

Turning to FIG. 2A of the drawings, the process 200 will be described in greater detail as one illustrative implementation of this system. Initially, a customer or taxpayer engages the tax preparer to prepare the customer's tax return (block 202), and this may include the customer meeting the tax preparer at the preparer's place of business in a face to face manner and requesting tax return preparation services. Upon agreeing to prepare and file the tax return for the customer, the tax preparer may take information from the customer relevant to preparing the tax return of the customer for the previous or past (tax) year (block 204) for which the return is to be prepared. Such information may include, for example, information on the customer's income in the past tax year. The tax preparer may utilize the information received to prepare the tax return for the customer (block 206) in a form that is suitable for filing with the relevant government entity, such as the IRS. Typically the form is an electronic form generated by software in memory 18 utilized to complete tax returns, with an underlying electronic record for the particular return being stored in a database 20 for the tax preparation entity's computer system 22, to permit submission of the electronic form (or at least the data entered therein and stored in the record) by electronic means over a suitable network to the IRS.

Additionally, with the customer's acquiescence, the tax preparer may take additional information from the customer that is not necessarily required for the completion and submission of the tax return, but may be relevant to the customer's suitability to participate in additional programs that may be offered to the customer by the tax preparer at the time of preparing the return. Such additional information may include, for example, information on the customer's current income level as contrasted with the information on the customer's past income obtained for the purposes of completing the tax return for the previous tax year. In the context of requesting such information, the tax preparer may inform the customer of the availability of programs and options that the customer may participate in if approved (block 208). One such program provides a secured credit card that is secured or collateralized by a portion of the customer's tax refund. Eligibility for participation in the secured credit card (SCC) program may initially be determined by the tax preparer, although this is not critical to the program, and the tax preparer may gather relevant information and pass that information on to another decision maker. For example, one determination of eligibility that may be made by the tax preparer is whether, based upon the tax return being prepared, the customer is entitled to receive a tax refund, as customers that are determined not to be eligible to receive a tax refund (e.g., owe additional taxes) are most likely not suitable for participation in the SCC program since the customer will not have funds from a tax refund to provide collateral for a credit card.

The tax preparer may also determine whether the customer wants to utilize a disbursement account (DA) for receiving the tax refund. The tax preparer may ask the customer whether the customer desires to have the tax refund sent directly to the customer from the IRS (block 210). If the customer indicates that he or she desires a direct refund (block 212), the process 200 terminates for the purposes of this disclosure, although the tax preparer and customer may take further steps that result in the filing of the tax return. If the customer responds that he or she does not want a direct form of refund (block 212), the tax preparer may ask the customer whether the customer would prefer to open a disbursement account (DA) for receiving the refund (block 214). Illustratively, the customer may opt to have the refund funds go into a DA to avoid the mailing of a paper check (which may require a permanent mailing address) and to potentially accelerate receipt of the refund funds by the customer. Further, use of the DA may allow tax preparer's fees to prepare and file the tax return to be taken from the refund funds deposited into the DA, and thus defer the customer's payment of the fees until the refund is received (otherwise the tax preparation fees may need to be paid at the time that the return is prepared). If the customer indicates that he or she does not desire to open a DA (block 216), then the process 200 terminates as the BCC program requires a DA. Generally, the customer may utilize a DA without opting to participate in the SCC program, but the customer may not participate in the SCC program without also utilizing a DA.

If the customer does indicate a desire or interest in utilizing a DA (block 216), then the process may continue as shown in FIG. 2B of the drawings. Based upon the customer's positive response to the inquiry regarding the DA (block 216), the tax preparer may also ask the customer if the customer would also want to apply for a secured credit card product from the SCC program that utilizes at least a portion of the refund as security or collateral for the credit card (block 220). Optionally, the inquiry to the customer may be presented by other means. If the customer indicates that he or she does not want to apply for the SCC program (block 222), the process 200 terminates (although further steps may be taken by the tax preparer to set up a DA). If the customer indicates an interest in applying for the SCC program (block 222) in response to the tax preparer's inquiry, then the customer may be informed that the tax refund is required to be deposited in a DA, and that a portion of the refund amount will be retained by the bank to secure or collateralize the secured credit card (block 224), which may be done by the tax preparer. The customer may also be informed of other applicable eligibility requirements for participation in the SCC program (block 226), which may also be performed by the tax preparer. A listing of the eligibility requirements may be provided to the customer, and may be in paper form. Other requirements may be communicated to the customer

Further inquiries may be made to the customer to determine if the customer meets the eligibility requirements for participation in the SCC program (block 228), and these inquiries may conveniently be made by the tax preparer, although the inquiries may be made in other suitable ways. For example, the customer may be required to have access to an information handling device through which the customer is able to access a website or other portal and provide and receive additional information regarding the SCC program, so the preparer may inquire regarding the customer's ability to access a computer or tablet or smartphone or other device with suitable network accessibility. It may also be determined if the customer agrees to receive electronic delivery of disclosure information regarding the SCC program, which may also be a requirement of program participation. The customer may be informed that eligibility for the program may require that the customer not directly file his or her tax return with the governmental entity (such as the IRS) or use other tax-related financial products to file his or her return if the customer is approved for participation in the SCC program. If the customer is filing a joint tax return covering more than one person, then only the primary taxpayer on the joint tax return may be allowed to participate in the SCC program. Further, each of the joint filers may be required to agree to pledge a portion of the tax refund to secure or collateralize the secured credit card account to be opened. Additional eligibility requirements may be utilized, and some of these illustrative requirements may be omitted.

The application may be reviewed with the customer (block 230), such as by the tax preparer, and the review may include the requirements for completing the application process and as well as actions that may occur after the application has been approved. Illustratively, the application for the SCC program may authorize various actions to be taken, such as authorization to open a deposit account (DA) for the customer, open a collateral account for the customer, and open a credit account for the customer if the customer is approved for the SCC program. The application may further include an authorization to obtain the credit report of the customer. These actions may be taken by the bank, or agents of the bank, as is suitable. The application may also include an authorization by the customer for the customer's tax refund to be directly deposited into a DA account and to be distributed in a manner described in the application among the various accounts and entities. These requirements are illustrative, as more or fewer requirements may be used.

The application may be presented to the customer in an electronic form through the system software and a display, and the application may also be reproducible in paper form for the customer to retain for his or her review and records. The electronic application form may include check boxes that are markable (whether by physical or electronic means) to indicate services that the customer requests, such as requesting the DA and requesting application for the SCC program. The customer may also indicate on the application that the fees for the tax preparation services are to be paid out of the refund funds received in the DA, if the fees are not paid at the time of receiving the services. The customer may further indicate on the application form the manner in which the customer wishes to receive the balance of the proceeds of the tax refund out of the DA (e.g., direct deposit to a bank account, prepaid card, paper check, etc.). The application form should also include any disclosures required to be made to the customer regarding the DA and the SCC program, including the collateral account as well as any other aspects of the program. The application program supporting the electronic form may be stored on computers systems 26 and/or 32

Turning now to FIG. 2C of the drawings, upon making a determination that the customer meets the eligibility requirements for the SCC program, a determination which may be made by the tax preparer or another entity, and the customer reviewing and completing the application, the customer may be required to sign the application for the SCC program to continue the application process (block 232). The signing of the application may be performed electronically if an electronic form is utilized, or physically signing a paper application form. The signing of the application may also include requiring any person jointly filing with the customer to also sign the application to authorize use of a portion of the refund funds to be placed in the collateral account to secure the SCC.

Once the customer has indicated a desire to utilize a DA, additional steps may be taken to determine the eligibility of the customer for opening a DA (block 234), and such steps may be taken to make a decision on the acceptability of the customer. In some implementations, this initial decision may be performed by the tax preparer on behalf of the bank, but the decision may be made by others including the bank. The preliminary eligibility investigation and determination may be made by the tax preparer to provide a more streamlined application process, especially for preliminary issues and determinations that do not require more specialized information access and sophisticated analysis. These steps may include, for example, verifying the customer's legal qualification to open an account by checking, for example, the customer's identity against various databases, such as the database maintained by the Office of Foreign Assets Control (OFAC) of the US Department of Treasury, which may disqualify the customer from setting up an account such as a DA. If it is determined that the customer is not approved for a DA (block 236), then the process 200 is terminated although the tax preparation services may continue to be provided without the use of a DA.

If the customer is approved for the opening of a DA (block 236), then a DA number may be assigned to the customer (e.g., by the tax preparer on behalf of the bank), and may include the DA number on the tax return for the purposes of directing the tax refund from the IRS to the DA (block 238). The DA number may also be included on the application for the SCC program by the tax preparer. If the customer has also requested application for the SCC program (block 240), then an SCC account number may be assigned to the customer, particularly if a SCC card is not provided to the customer at this point, and the SCC account number may be entered in the customer's record on the database 20 to provide a means of tracking the customer's information. In some implementations, the customer's SCC program packet 36 may be provided to the customer with information and disclosures, as well as in some cases a card object that has not been activated. In other implementations, the program packet may be retained in the customer's file 38 (block 242) at the tax preparer's office until receipt of final confirmation of the acceptance of the customer for the SCC program.

The tax preparer may file the customer's tax return with the relevant government body, such as the IRS (block 244). If the customer has not already been provided with copies of the disclosures relating to the DA and collateral account, as well as any other applicable disclosures, the customer is then provided with the copies which include the customer's (and any joint filers) signatures. The customer has the option to leave the tax preparer's place of business unless, for example, the customer wants to wait for receipt of the acknowledgement of the tax return filing from the IRS before leaving to possibly remedy any problems in the return if the return is not acknowledged or is flagged by the IRS. If the client has applied for the SCC program, the process 200 waits to receive an acknowledgement of receipt of the tax return from the IRS (block 246).

As further illustratively shown in FIG. 2D, a determination is made whether the IRS transmits an acknowledgement of receipt of the tax return (block 250). If the IRS does not acknowledge receipt of the tax return within a predetermined period (block 252), then the customer's application for the SCC program may be denied on that basis and the customer may be sent a notice of adverse action that may provide explanation of the reasons for disapproval of the customer's application. The notice may be sent by the bank or one of its agents. The length of the predetermined time period from the filing of the tax return may vary, but in some of the most preferred implementations, the period ranges from 10 to 40 days, and in some of the more preferred implementations ranges between 25 and 35 days. In one highly preferred implementation, the predetermined time period is approximately 30 days. Further, the customer may be notified of the denial, such as by the tax preparer, of the failure of the IRS to acknowledge receipt of the tax return (block 254). The customer may return to the tax preparer and attempt to correct any errors in the tax return and resubmit the return to the IRS. Upon the correction of the errors and resubmission of the tax return, the customer may be offered the option to reapply for the DA and the SCC program (block 256) by the tax preparer.

If the IRS acknowledges receipt of the tax return within the predetermined period (block 250), then the IRS acknowledgment is recorded in the customer's record in the database of the system (block 258) and the bank may be informed of the acknowledgment by the tax preparer as the tax preparer typically receives the acknowledgement.

The bank may then perform a further conditional approval process (block 260) for the customer's application for the SCC program. In some implementations, the bank may perform an OFAC search (block 262) that is additional to the one performed by the tax preparer as a part of the conditional approval process. The bank may also perform a check of credit bureau records on the customer (block 264), and check the customer's eligibility against the program's minimum eligibility requirements (block 266) based at least in part upon information turned up by the credit bureau check. The consideration by the bank of the customer's eligibility may extend beyond the more basic eligibility requirements previously considered by the tax preparer and the minimum eligibility requirements, and may include scoring of the customer's creditworthiness based upon information contained in the credit bureau information obtained on the customer.

The underwriting process may consider the amount of the customer's expected tax refund in the decision regarding the customer's eligibility for the program (block 268) which is not a part of the credit bureau information and heretofore not recognized as a part of underwriting for a secured credit card. For example, the amount of the expected tax refund may be considered in determining the collateral amount for the secured credit card.

Now turning to FIG. 2E of the drawings, a determination is made whether the customer will be conditionally approved for the SCC program (block 270). If the customer is not conditionally approved, such as based upon the scoring of the information contained in the credit bureau report, the customer is sent a notice of adverse action (block 272) which may be done by the bank or its agents. Upon the decision of denial for the SCC program, the tax preparer may remove the SCC program packet from the customer's file for possible reassignment to another customer applying for the SCC program (block 274).

If the customer is conditionally approved for participation in the SCC program (block 270), the bank may communicate the conditional approval to the tax preparer if necessary (block 276). The bank may communicate the SCC information to a credit card processor entity 40 (block 280), and the credit card processor may create a credit card account and collateral account for the customer (block 282), such as at the direction of the bank. The conditional approval for the SCC program and the amount of the secured credit line may be communicated to the customer (block 284) by, for example, the bank or the tax preparer. The “conditional” nature of the approval is based upon the requirement that the customer complete an online application prior to the receipt of the customer's refund from the IRS, or at the end of the passage of a predetermined period from the date of the conditional approval, whichever occurs first. The predetermined period may range from approximately 10 to approximately 40 days, and in some of the more preferred implementations ranges between approximately 25 and approximately 35 days. In some highly preferred implementations, the predetermined time period is approximately 30 days. If not already provided to the customer, the tax preparer may provide the customer with the SCC participation packet 36 (block 286) from the customer's file at the tax preparer's place of business, which may require that the customer return to the tax preparer's place of business to pick up the packet 36.

Now turning to FIG. 2F of the drawings, the customer may take steps to activate the SCC (block 290). In some implementations the customer may access the activation website 28 through a communication network such as the Internet that may be maintained or administered by the bank, although not necessarily. The customer may access a specialized SCC activation page on the website (block 292) based upon information that is provided to the customer, such as in the SCC participation packet. For the purposes of this disclosure, reference to a website and a webpage also includes application programs that may be downloaded to devices, such as small application programs sometimes referred to as “apps”. Also, the activation steps may comprise communication over a voice communication network such as by telephone.

As a part of the activation process to complete the application, the customer may be required to create a user account by providing information such as a user name, a password, answers to security questions, and by providing or verifying an email address (block 294). Additional requirements may be made for the customer. The website may transmit a notification to the customer of the pending status of the SCC application if the IRS acknowledgment of the tax return is pending (e.g., has not been received by the tax preparer) at the time that the customer accesses the website (block 296). A determination is made whether, at the time of the setup of the account, the tax refund has already been received into the DA, or if the predetermined period has passed since the conditional approval. If the refund has already been received, or the predetermined time period has (since the conditional approval) passed at the time of the account setup, then the customer is informed that he or she is ineligible (block 304) to complete the application for the SCC program and the customer is sent a notice of adverse action (block 306). If the refund has not been received and the predetermined time period has not passed (block 302), then the customer is provided with suitable disclosures regarding the secured credit card program (block 308) as the customer may have already received disclosures regarding the DA 42 and collateral account 44.

Turning to FIG. 2G of the drawings, the customer's signature of acceptance of the terms of the disclosure regarding the credit card program is obtained (block 310), and may be in the form of an electronic signature obtained through the customers' interaction with the website page. The consent of the customer to receive electronic delivery of disclosures may also be obtained from the customer (block 312). An inquiry may also be submitted to the customer to find out whether the customer will permit payments for balances on the secured credit card to be automatically deducted from one of the customer's accounts, such as a checking account (block 314). The webpage may also display the particular manner of disbursement of the funds of the tax refund from the DA, which will include disbursement of an amount to the collateral account for the secured credit card, and an acknowledgment of the disbursements may be obtained from the customer (block 316). All disclosure materials may be provided in a form that may be printed from the website using the computer employed by the customer to access the website. Further, if any remaining problems exist with the customer's SCC program application that would prevent or hinder the completion of the acceptance process (block 318), an attempt may be made to resolve these problems through the customer's website access session. Such problems may relate to, for example, red flags or fraud alerts that may have been discovered during the conditional application process and may be cleared up through further or corrected information from the customer. The customer may be provided with instructions for clearing up any remaining issues that may be resolved by the customer. If problems with the SCC program application remain unresolved (block 320), then the customer's application may not be allowed to proceed in the process 200. The application may be denied (block 322) and the customer may be sent a notice of adverse action, and process 200 is terminated. If no unresolved problems remain (block 320), then the application is approved (block 324).

Turning to FIG. 2H of the drawings, the IRS may provide notice of the transfer of the funds of the tax refund to the DA 42 prior to the transfer being commenced (block 330). The notice may be provided, for example, to the bank and the processor of the DA (such as the tax preparer) prior to the time of transmission. The funds may be received into the DA (block 332) through a transfer via an automated clearinghouse (ACH) 46. The funds may be distributed from the disbursement account (block 334) according to the hierarchy of payments set forth in the disclosures to the customer that form a part of the agreement for participation in the SCC program (block 334). The process 200 may then terminate.

Turning to FIG. 2I of the drawings, an illustrative distribution of the funds from the DA 42 is set forth in greater detail. In the illustrative distribution of funds, the collateral account 44 for the secured credit card may be funded first (block 340). In the most preferred embodiments, this transfer to the collateral account occurs without the funds being passed to the customer Secondly, the bank revenue account may be funded for the bank's DA handling fee (block 342). Funds may be transferred to the tax preparer's account in the amount of a balance of the DA handling fee (block 344), and the account of the tax preparer may be funded for any unpaid tax return preparation fees if the customer opted to pay the tax preparation fees from the proceeds of the tax refund (block 346). The remainder of the funds in the DA after the application of the funds to the various fees and collateral amounts may be to the customer in a form selected by the customer, such as direct transfer to the customer's bank account, paper check, or prepaid card, as examples (block 348). The process 200 is then terminated. The secured credit card is then available for use by the customer.

It should be recognized that although the various steps and actions and functions described herein may be described as being taken by specific entities, these steps and actions are not limited to those entities and may be taken by other entities described herein as well as other entities not described.

While the illustrative implementations of various aspects of the disclosure relate to the provision of tax return preparation services, and the handling of a tax refund as a result of providing such services, it should be recognized that the scope of the disclosure is not necessarily limited only to the context of these services, and those skilled in the art will. Upon consideration of the present disclosure, recognize other applications for which aspects of the disclosure may be utilized.

It should also be appreciated from the foregoing description that, except when mutually exclusive, the features of the various embodiments and implementations described herein may be combined with features of other embodiments as desired while remaining within the intended scope of the disclosure.

With respect to the above description, it should be realized that the relationships for the elements and steps and acts of the disclosed embodiments and implementations may include variations in form, function and manner of operation, assembly and use not specifically stated herein. Such variations are deemed readily apparent and obvious to one skilled in the art in light of the foregoing disclosure, and all equivalent relationships to those illustrated in the drawings and described in the specification are intended to be encompassed by the present disclosure.

Therefore, the foregoing is considered as illustrative only of the principles of the disclosure. Further, since numerous modifications and changes will readily occur to those skilled in the art based upon this disclosure, it is not desired to limit the disclosed subject matter to the exact construction and operation shown and described, and accordingly, all suitable modifications and equivalents may be resorted to that fall within the scope of the claims.

We claim:

1. A method of providing a secured credit card product to a customer comprising:
receiving eligibility information transmitted over a communication network from a tax preparation entity, said eligibility information regarding preparation of a tax return for the customer including an amount of a tax refund that the customer is entitled to receive;
determining if the customer meets eligibility requirements for the secured credit card product based in part upon the eligibility information; and
transmitting a conditional approval for the secured credit card product for the customer if the customer meets the eligibility requirements;
if the customer is conditionally approved, receiving additional eligibility information over a communication network from the customer to approve the customer for the secured credit card product; and
receiving the tax refund in a disbursement account and transferring at least a portion of the amount of the tax refund of the customer from the disbursement account to a collateral account to provide collateral for the secured credit card product of the customer.

2. The method of claim 1 wherein the receiving of additional eligibility information includes requiring the customer to access a website through the communications network to take further actions to be approved for the secured credit card program.

3. The method of claim 2 further comprising requiring that the accessing of the website and the further actions be taken in a predetermined period of time.

4. The method of claim 2 further comprising requiring that the accessing of the website and the further actions be taken prior to issuance of the tax refund for the customer.

5. The method of claim 2 further comprising disqualifying the customer from further consideration for the secured credit card program if the customer fails to access the website and take the further actions.

6. The method of claim 1 further comprising offering the secured credit card product to the customer in conjunction with preparing the tax return for the customer by the tax preparation entity.

7. The method of claim 1 wherein determining if the customer meets eligibility requirements includes determining an amount of collateral required for the secured credit card product to be transferred from the tax refund of the customer.

8. The method of claim 7 wherein determining the amount of collateral required for the secured credit card is based at least in part upon the amount of the tax refund that the customer is entitled to receive.

9. The method of claim 1 wherein determining if the customer meets eligibility requirements includes performing an initial evaluation of the customer by the tax preparation entity for the secured credit card product, transmitting results of the initial evaluation over the communication network to a bank offering the secured credit card program, and performing a further evaluation of the customer by the bank.

10. The method of claim 9 wherein determining if the customer meets eligibility requirements includes checking credit bureau records of the customer and submitting information about the customer to an underwriting process to determine an amount of collateral to be transferred from the tax refund in the disbursement account.

11. A method of providing a secured credit card product to a customer comprising:
preparing a tax return for a customer for a previous year;
determining, based upon the preparation of the tax return, whether the customer is entitled to receive a tax refund;
if the customer is entitled to receive a tax refund, offering a secured credit card product to the customer;
determining if the customer meets eligibility requirements for the secured credit card product; and
receiving the tax refund and using at least a portion of the amount of the tax refund of the customer to provide collateral for the secured credit card product of the customer.

12. The method of claim 11 further comprising, if the customer meets the eligibility requirements for the secured credit card program, conditionally approving the customer for the program and requiring the customer to access a website through a communications network to take further actions to be approved for the secured credit card program.

13. The method of claim 12 further comprising requiring that the accessing of the website and the further actions be taken in a predetermined period of time.

14. The method of claim 12 further comprising requiring that the accessing of the website and the further actions be taken prior to issuance of the tax refund for the customer.

15. The method of claim 12 further comprising, if the customer is conditionally approved, disqualifying the customer from further consideration for the secured credit card program if the customer fails to access the website and take the further actions.

16. The method of claim 12 further comprising, if the customer is conditionally approved, disqualifying the customer from further consideration for the secured credit card program if the customer fails to access the website and take the further actions in a predetermined period of time.

17. The method of claim 12 further comprising, if the customer is conditionally approved, disqualifying the customer from further consideration for the secured credit card program if the customer fails to access the website and take the further actions prior to issuance of the tax refund for the customer.

18. The method of claim 11 wherein receiving the tax refund further comprises receiving the tax refund into a disbursement account and distributing at least a portion of the amount of the tax refund into a collateral account securing the secured credit card product.

19. The method of claim 11 wherein the offering of the secured credit card product is made in conjunction with preparing the tax return for the customer by a tax preparation entity.

20. The method of claim 11 wherein determining if the customer meets eligibility requirements includes requesting current income level information from the customer by a tax preparation entity preparing the tax return.

21. The method of claim 11 wherein determining if the customer meets eligibility requirements includes performing an initial evaluation of the customer by a tax preparation entity for the secured credit card product, transmitting results of the initial evaluation over a communication network to a bank offering the secured credit card program, and performing a further evaluation of the customer by the bank.

22. The method of claim 21 wherein determining if the customer meets eligibility requirements includes performing a further evaluation of the customer includes checking credit bureau records of the customer and submitting information about the customer to an underwriting process to determine a secured credit amount for a secured credit card account for the customer.

23. A system for providing a secured credit card product to a customer, comprising:
a first computer associated with a bank and a second computer associated with a tax preparation entity, the first computer being communicatively connected to the second computer by a communications network, the first computer including a processor and memory; and
a computer program product stored on a tangible computer memory media associated with the first computer and operable on at least the first computer, the computer program product including instructions executable by at least the first computer to cause the first computer to perform the steps of:
receiving eligibility information transmitted over the communication network from the second computer, said eligibility information comprising information regarding preparation of a tax return for the customer by the tax preparation entity for the customer and including an amount of a tax refund that the customer is entitled to receive;
determining if the customer meets eligibility requirements for the secured credit card product based in part upon the eligibility information; and
transmitting a conditional approval for the secured credit card product for the customer if the customer meets the eligibility requirements;
if the customer is conditionally approved, receiving additional eligibility information over the communication network from the customer to approve the customer for the secured credit card product;
transmitting a notification to the second computer regarding approval of the customer for the secured credit card product; and
transferring at least a portion of the amount of the tax refund of the customer from a disbursement account to a collateral account to provide collateral for the secured credit card product of the customer.

24. The system of claim 23 wherein the receiving of additional eligibility information includes providing a website accessible to the customer through the communications network to receive the additional eligibility information.

25. The system of claim 24 further comprising disqualifying the customer from further consideration for the secured credit card program if the customer fails to access the website and provide the additional eligibility information.

26. The system of claim 23 wherein determining if the customer meets eligibility requirements includes determining an amount of collateral required for the secured credit card product to be transferred from the tax refund of the customer.

27. The system of claim 26 wherein determining the amount of collateral required for the secured credit card is based at least in part upon the amount of the tax refund that the customer is entitled to receive.

28. A computer program product stored on a tangible computer memory media associated with a first computer and operable on the first computer, the computer program product including instructions executable by the first computer to cause the first computer to perform the steps of:
receiving eligibility information transmitted over the communication network from a second computer, said eligibility information comprising information regarding preparation of a tax return for the customer by the tax preparation entity for the customer and including an amount of a tax refund that the customer is entitled to receive;
determining if the customer meets eligibility requirements for the secured credit card product based in part upon the eligibility information; and
transmitting a conditional approval for the secured credit card product for the customer if the customer meets the eligibility requirements;
if the customer is conditionally approved, receiving additional eligibility information over a communication network from the customer to approve the customer for the secured credit card product;
transmitting a notification to the second computer regarding approval of the customer for the secured credit card product; and
transferring at least a portion of the amount of the tax refund of the customer from a disbursement account to a collateral account to provide collateral for the secured credit card product of the customer.

29. The computer program product of claim 28 wherein the receiving of additional eligibility information includes providing a website accessible to the customer through the communications network to receive the additional eligibility information.

30. The computer program product of claim 28 wherein determining if the customer meets eligibility requirements includes determining an amount of collateral required for the secured credit card product to be transferred from the tax refund of the customer.
